(19) United States
(12) Patent Application Publication
(10) Pub. No.: US 2026/0217247 A1
(43) Pub. Date: Jul. 30, 2026

(54) SYSTEMS AND METHODS FOR AUTONOMOUSLY FOLLOWING A BIKE GROUP

(71) Applicant: Toyota Motor North America, Inc., Plano, TX (US)

(72) Inventors: Jose E. Cervantes Gomez, The Colony, TX (US); Bryan Else Yamasaki, Aubrey, TX (US); Anna D. Shelukha, Lewisville, TX (US)

(73) Assignees: Toyota Motor North America, Inc., Plano, TX (US); Toyota Jidosha Kabushiki Kaisha, Toyota-shi Aichi-ken (JP)

(21) Appl. No.: 19/040,113

(22) Filed: Jan. 29, 2025

(51) Int. Cl. B60W 30/16

(52) U.S. Cl. CPC B60W 30/16; B60W 2554/4026; B60W 2554/4041; B60W 2554/802

(57) ABSTRACT

Systems, methods, and other embodiments described herein relate to an autonomous vehicle with bicycle-following capabilities. The system includes a processor and a memory storing machine-readable instructions. The machine-readable instructions, when executed by the processor, cause the processor to 1) identify a group of cyclists to be followed by a vehicle with autonomous driving capability and 2) establish a following distance for the vehicle. The following distance is a distance maintained between the vehicle and the group. The machine-readable instructions, when executed by the processor, also cause the processor to 1) calculate a width of the group and 2) control the vehicle based on the following distance and the width of the group.

### TECHNICAL FIELD

The subject matter described herein relates, in general, to an autonomous vehicle that automatically follows a group of cyclists (i.e., a peloton) and, more particularly, to a vehicle that autonomously follows a group of cyclists based on the width of the group.

### BACKGROUND

Cycling is a popular hobby across the globe, but it can be dangerous. Specifically, cyclists may occupy the same roadways used by countless other entities, such as automobiles and motorcycles. The increased quantity of cyclists and motorists on a roadway increases the potential likelihood of cyclist/vehicle collisions. This may be particularly problematic in urban areas where the number of motorists exceeds rural roadways. Being much smaller than the vehicle and not protected by a steel frame, the cyclist is likely to suffer the more significant injury in any cyclist/automobile collision.

In some cases, for social connection, safety, and/or energy conservation, cyclists may ride together in a group or “peloton.” In bicycle races, groups of cyclists may form into different “pelotons,” which may benefit the individual cyclists. Peloton riding reduces wind resistance on the cyclists within the group such that individual cyclists expend less energy throughout the race. However, even riding in a peloton does not ensure the complete safety of cyclists from collisions with other roadway users.

### SUMMARY

In one embodiment, example systems and methods relate to a manner of improving cyclist safety when traveling in a group and on a road that is populated by other road users such as vehicles.

In one embodiment, a group following system for improving cyclist safety when traveling in a group and on a road populated by other road users such as vehicles is disclosed. The group following system includes one or more processors and a memory communicably coupled to the one or more processors. The memory stores instructions that, when executed by the one or more processors, cause the one or more processors to 1) identify a group of cyclists to be followed by a vehicle with autonomous driving capabilities and 2) establish a following distance for the vehicle. The following distance is a distance maintained between the vehicle and the group. The memory also stores instructions that, when executed by the one or more processors, cause the one or more processors to 1) calculate a width of the group and 2) control the vehicle based on the following distance and the width of the group.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a group following system that is associated with autonomously following a group of cyclists.

FIGS. 3A-3C depicts one embodiment of a sensor-based bike-following system for following a group of cyclists.

FIGS. 4A and 4B depict one embodiment of an antenna-based group following system for following a group of cyclists.

FIG. 5 illustrates a flowchart for one embodiment of a method that is associated with autonomously following a group of cyclists.

### DETAILED DESCRIPTION

Systems, methods, and other embodiments associated with improving the safety of groups of cyclists traveling on roadways occupied by other users are disclosed herein. As previously described, cycling is a popular hobby that is inherently dangerous on account of occupying the same environment (e.g., roadways) as larger, heavier, and fast-traveling vehicles.

For social, safety, or efficiency reasons, cyclists may prefer to ride as a part of a group or “peloton.” For example, motorists may more readily observe a large group of cyclists on a roadway. Moreover, group riding may lead to increased individual performance as the cyclists experience less wind resistance when riding as part of the group. However, while safer and potentially more efficient than riding individually, riding as a group still presents a cyclist with inherent danger, again due to potential collisions with heavier, larger, and fast-traveling vehicles.

To improve peloton safety, a human-operated vehicle may follow behind the group of cyclists. However, in many instances, it may be infeasible or inconvenient for the cyclist to find an individual to operate the vehicle. Accordingly, the present specification describes a system that controls a vehicle to follow a group of cyclists autonomously. Specifically, the group following system may identify many individual cyclists within the group and identify the width of the group. The system may then control the vehicle to follow behind the group based on the detected width of the group. The system may be sensor-based, transceiver-based, or a combination of both. In a sensor-based system, environment sensors of the vehicle may detect a leftmost and rightmost cyclist within the group, and a processor may calculate the width of the group. The autonomous vehicle may detect movements of the group and control vehicle systems (e.g., acceleration, braking, and steering systems) to position/move the vehicle laterally behind the group based on the width. In this example, the vehicle is controlled (e.g., navigated) based on detected cyclist group movement.

In a transceiver-based system, the group following system may receive, from at least one cyclist/bicycle device in the group, information from which the width of the group is determined, for example, geo-locational information for different entities within the group. The processor may then calculate the width and control the vehicle systems (e.g., acceleration, braking, and steering systems) to position/move the vehicle laterally behind the group based on the geo-locationally calculated width of the group. In this example, the vehicle is controlled (e.g., navigated) based on received signals from the cyclists that indicate the cyclist/bicycle position and/or movement.

In either case, the group following system aggregates the location of many different data points (e.g., cyclist positions) to determine a lateral following point along a longitudinal path behind the cyclists.

In an example, the following distance may be automatically or manually set and may be sufficient such that 1) even when a vehicle is involved in a rear-end collision, the group of cyclists is not impacted and 2) the vehicle does not collide with a cyclist who has stopped or fallen from their bicycle.

In some examples, the commands to follow and protect the group may supersede other vehicle commands. For example, a group of ten cyclists may occupy more than one lane along a roadway. In this example, an automated driving module that may otherwise prevent a vehicle from changing lanes may be temporarily disabled so that the vehicle can position itself centrally behind the group across multiple lanes, in a position to provide enhanced safety to the group.

In an example, the bike following service may be on a for-hire basis. That is, the availability of vehicles with autonomous following/driving capability may be limited. Accordingly, in this example, a cyclist may search for vehicles in the vicinity with autonomous following capabilities and reserve such. On the agreed date, time, and location, the vehicle comes to the bicycle location and starts the autonomous bike following the abovementioned operation. At the end of the session, the vehicle disengages from the group and continues to the next appointment or another predetermined location.

As described in more detail below, in some cases, the group following system may control the vehicle components to increase the visibility and/or safety of the group. For example, vehicle lights may be turned on and/or intensified in low-light conditions. As another example, upon detecting a passing vehicle, the vehicle may move laterally to impede a path between the passing vehicle and the group.

In this way, the disclosed systems, methods, and other embodiments improve cyclist safety by enabling vehicles to follow the cyclists without human operation, which human operation may be inconvenient to employ. The vehicle may detect the cyclists (either through sensor-based methods, transceiver-based methods, or both) and follow at an appropriate distance (determined empirically or set by a user) to protect the cyclists without increasing the risk of harm. This protection is provided to cyclists who do not have access to autonomous vehicles through, for example, a vehicle rental service. The protective effect is enhanced in low-light conditions where the headlights of the vehicle may provide extra visibility to the cyclists. At the same time, the taillights increase the visibility of the group to vehicles behind the group.

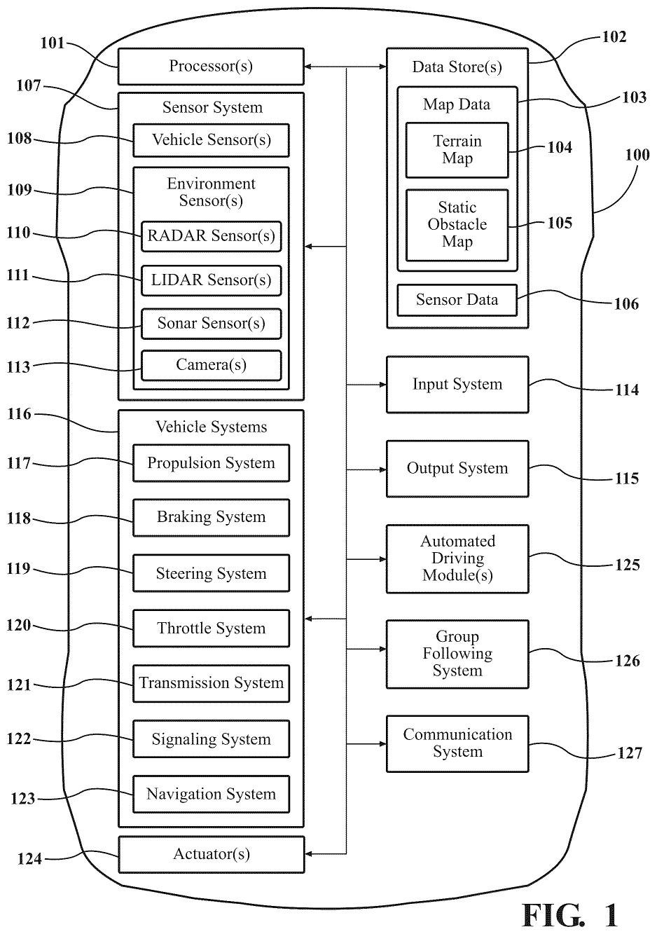

Referring to FIG. 1, an example of a vehicle 100 is illustrated. As used herein, a “vehicle” is any form of transport that may be motorized or otherwise powered. In one or more implementations, the vehicle 100 is an automobile. While arrangements will be described herein with respect to automobiles, it will be understood that embodiments are not limited to automobiles. In some implementations, the vehicle 100 may be a robotic device or a form of transport that, for example, includes sensors to perceive aspects of the surrounding environment, and thus benefits from the functionality discussed herein associated with autonomously following groups of cyclists.

The vehicle 100 also includes various elements. It will be understood that in various embodiments it may not be necessary for the vehicle 100 to have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

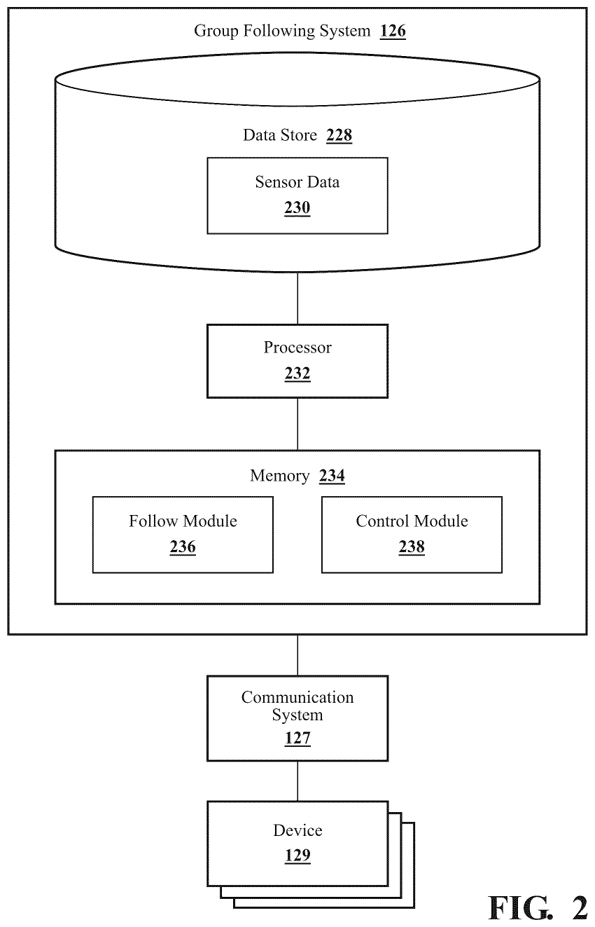

Some of the possible elements of the vehicle 100 are shown in FIG. 1 and will be described along with subsequent figures. However, a description of many of the elements in FIG. 1 will be provided after the discussion of FIGS. 2-5 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 100 includes a group following system 126 that is implemented to perform methods and other functions as disclosed herein relating to improving cyclist following by basing such on a determined width of the group.

Moreover, the group following system 126, as provided for within the vehicle 100, functions in cooperation with a communication system 127. In general, the communication system 127 facilitates communication between the vehicle 100 and other devices 129 in its environment, such as location-transmitting devices on a bicycle or a location-transmitting personal device of a cyclist.

In one embodiment, the communication system 127 communicates according to one or more communication standards. For example, the communication system 127 can include multiple different antennas/transceivers and/or other hardware elements for communicating at different frequencies and according to respective protocols. The communication system 127, in one arrangement, communicates via a communication protocol, such as a WiFi, dedicated short-range communication (DSRC), vehicle-to-infrastructure (V2I), vehicle-to-vehicle (V2V), or another suitable protocol for communicating between the vehicle 100 and other entities in the cloud environment. Moreover, the communication system 127, in one arrangement, further communicates according to a protocol, such as global system for mobile communication (GSM), Enhanced Data Rates for GSM Evolution (EDGE), Long-Term Evolution (LTE), 3G, 4G, 5G, or another communication technology that provides for the vehicle 100 communicating with various remote devices (e.g., a cloud-based server). In any case, the group following system 126 can leverage various wireless communication technologies to provide communications to other entities, such as members of the cloud-computing environment. In an example, the communication system 127 communicates directly with the other devices 129 for example, using an infrared or Bluetooth® link.

With reference to FIG. 2, one embodiment of the group following system 126 of FIG. 1 is further illustrated. The group following system 126 is shown as including a processor 232. The processor 232 may be the processor 101 of the vehicle 100, the group following system 126 may include a separate processor from the processor 101 of the vehicle 100, or the group following system 126 may access the processor 101 through a data bus or another communication path that is separate from the vehicle 100. In one embodiment, the group following system 126 includes a memory 234 that stores a follow module 236 and a control module 238. The memory 234 is a random-access memory (RAM), read-only memory (ROM), a hard-disk drive, a flash memory, or another suitable memory for storing the modules 236 and 238. The modules 236 and 238 are, for example, computer-readable instructions that, when executed by the processor 232, cause the processor 232 to perform the various functions disclosed herein. In alternative arrangements, the modules 236 and 238 are independent elements from the memory 234 that are, for example, comprised of hardware elements. Thus, the modules 236 and 238 are alternatively application-specific integrated circuits (ASICs), hardware-based controllers, a composition of logic gates, or another hardware-based solution.

Moreover, in one embodiment, the group following system 126 includes the data store 228. The data store 228 is, in one embodiment, an electronic data structure stored in the memory 234 or another data storage device and that is configured with routines that can be executed by the processor 232 for analyzing stored data, providing stored data, organizing stored data, and so on. Thus, in one embodiment, the data store 228 stores data used by the modules 236 and 238 in executing various functions.

In one embodiment, the data store 228 stores sensor data 230. In general, the sensor data 230 is data by which the follow module 236 identifies the individual entities (e.g., bicycles/cyclists) within a group. That is, as described above, the group following system 126 controls the vehicle 100 to not only follow behind a group of bicycles but follow behind the bicycles at a predetermined lateral position (given the bicycles are traveling along a longitudinal path) based on the width of the group. Accordingly, the sensor data 230 may include the data by which the group following system 126 may determine the width of the group.

The sensor data 230 may be data collected by the environment sensor(s) 109 that sense a surrounding environment (e.g., external) of the vehicle 100. That is, as described in connection with FIG. 1, the environment sensor(s) 109 (which may include radar sensors 110, LiDAR sensors 111, sonar sensors 112, or cameras 113) may detect moving obstacles in the environment of the vehicle 100. The follow module 236 may include a processor (such as an image processor) that identifies individual objects (e.g., bicycles or cyclists) within an output (e.g., an image) and can track such through a sequence of frames, identifying their relative location to other objects (e.g., bicycles or cyclists) or their position in the environment (e.g., their geographical coordinates). Accordingly, the sensor data 230 may include these images or other environment sensor(s) 109 output by which the follow module 236 identifies individual bicycles/cyclists and determines the width of a group of such.

Moreover, the continued collection of the sensor data 230 may allow the vehicle 100 to follow the group. In this example, the detected movements of the group of cyclists may determine and control the movement of the vehicle 100. Put another way, the group following system 126, in conjunction with the automated driving module(s) 125 and vehicle systems 116, may adjust the longitudinal and lateral position and speed of the vehicle 100 based on the longitudinal and lateral position and speed of the group.

The sensor data 230 may include data from rearward environment sensor(s) 109. As described above, the group following system 126 may control the vehicle 100 to block a path between a passing vehicle and the group. Accordingly, the sensor data 230 may also include this rearward-facing sensor data such that oncoming vehicles may be detected and the group protected from such.

In an example, the sensor data 230 may be data collected by sensors of other devices 129. In an example, a device 129 is an electronic device on a bicycle that includes memory, a processor, and a transceiver for communicating with the group following system 126. In another example, the device 129 is a personal electronic device of a user (e.g., phone, tablet, watch, etc.) that includes memory, a processor, and a transceiver for communicating with the group following system 126. For example, as described above, in some cases the width of the group and the location of the group may be determined based on transmitted location coordinates of the bicycles themselves or of devices used by the cyclists in the group. That is, personal devices of cyclists in a group, or electronic devices of the bicycles themselves, may include sensors such as global positioning system (GPS) sensors that determine the location of the cyclist or bicycle. Accordingly, following a handshake or pairing operation where the communication system 127 of the group following system 126 is communicatively coupled to one or more bicycle devices or user devices of cyclists, the bicycle device or cyclist device may transmit coordinate locations to the group following system 126 as sensor data 230. With this sensor data 230 stored in the data store 228, the follow module 236 may determine the width of the group and track the movement/position of the group over time. As such, the sensor data 230 may include the location of the cyclists/bicycles as determined by location sensors of the devices 129 of the cyclists/bicycles.

In an example, the sensor data 230 may be periodically or cyclically collected. That is, the sensor data 230 may reflect a time-based representation of the location of the individual cyclists, whether the sensor data 230 is environment sensor(s) 109 output data or transmitted location data. As such, the vehicle 100 may continuously update its lateral and longitudinal position based on the movement of the group and/or individual entities within the group. For example, a leftmost cyclist may move closer to the group, thus reducing the lateral width of the group. Based on this adjustment, the vehicle 100 may change position to be centered behind the group again.

The time-based representation may also be used to differentiate non-group cyclists from group cyclists. For example, it may be that a single cyclist is passing the group but is not part of the group. Accordingly, a few individual frames of images may depict the non-group cyclist. However, if a cyclist is not detected in a threshold number of sequential frames of the environment sensor(s) 109 output, the group following system 126 may deem this cyclist as a non-group cyclist and may thus disregard the location of this cyclist when determining the width of the group. Similarly, the group following system 126 may differentiate other non-group entities from group cyclists.

In one embodiment, the data store 228 stores the sensor data 230 along with, for example, metadata that characterizes various aspects of the sensor data 230. For example, the metadata can include cyclist identifying information, time/date stamps from when the separate sensor data 230 was generated, and so on. For example, the time stamp data may be used to differentiate non-group entities from the group cyclists. Moreover, the metadata may include an identifier of the device 129 from which the information is received. This device-identifying metadata may facilitate the tracking of the device 129 (e.g., cyclist device or bicycle device) through multiple frames. As another example, the metadata may include an identifier of a tracked object in environment sensor(s) 109 output. Accordingly, the follow module 236 may track individual entities through frames of output based on an associated identifier.

The group following system 126 also includes various modules 236 and 238 that carry out various functions. In general, the follow module 236 includes instructions that, when executed by the processor 232, cause the processor 232 to 1) identify a group of cyclists to be followed by a vehicle with autonomous driving capability, 2) establish a following distance for the vehicle, which following distance is a distance maintained between the vehicle and the group, and 3) calculates a width of the group.

With regards to identifying the group, as described above, this may be performed in a variety of ways. Where the group following system 126 is an environment sensor output-based system, the follow module 236 may include instructions that cause the processor 232, which may include image processing capabilities, to identify the bicycles/cyclists that form the group based on the output of the environment sensors 109. That is, these environment sensor(s) 109 may detect objects within an output and may able to track these objects over time, identify real-world positions of these objects, and the relative position of these objects to other objects in the image (e.g., a distance between these objects). Accordingly, the follow module 236 may identify those objects that are cyclists within a group and track such through multiple frames of output data.

In one particular example, the follow module 236 may perform image analysis, for example, based on machine learning where cyclists and bicycles may be differentiated from other objects such as vehicles, stationary objects such as roadway infrastructure, and pedestrians based on any number of characteristics such as size, dimensions, traveling speed, and feature presence That is, cyclists have different physical characteristics as compared to other objects potentially on a roadway, and a machine-vision follow module 236 may identify these differences in detected objects to classify an object as a cyclist/bicycle as differentiated from other non-bicycle objects such as vehicles, pedestrians, animals, and infrastructure elements. In an example, the machine learning may be supervised or unsupervised machine learning.

In an example, the follow module 236 may analyze metadata associated with the environment sensor(s) 109 output to identify the group. For example, a peloton of cyclists to be followed may be relatively close to one another for an extended period. As such, those cyclists or bicycles that make up the peloton to be followed may be identified as those simultaneously identified in a threshold number of sequential frames of environment sensor(s) 109 output. Objects identified in a sub-threshold number of frames may be differentiated as non-group objects (e.g., passing cyclists, vehicles, pedestrians, etc.).

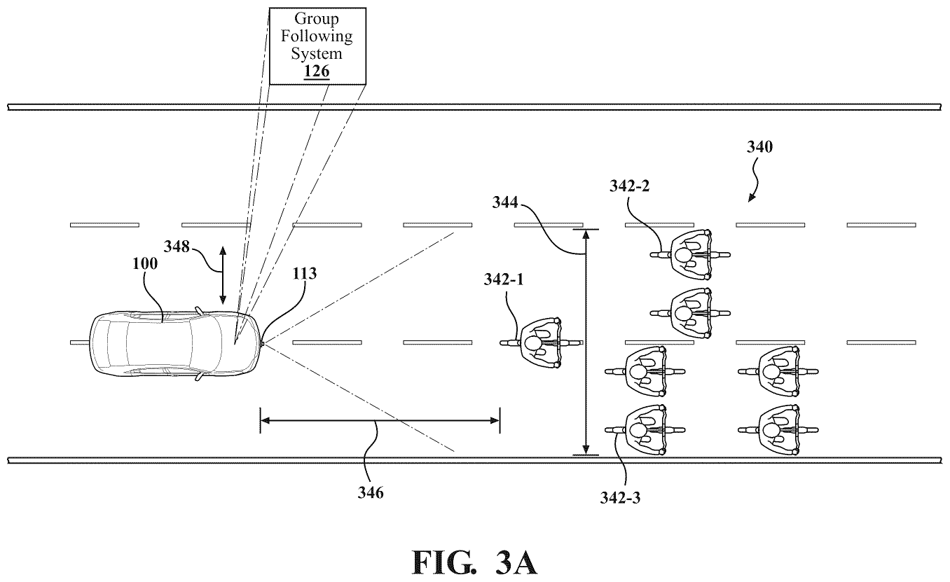

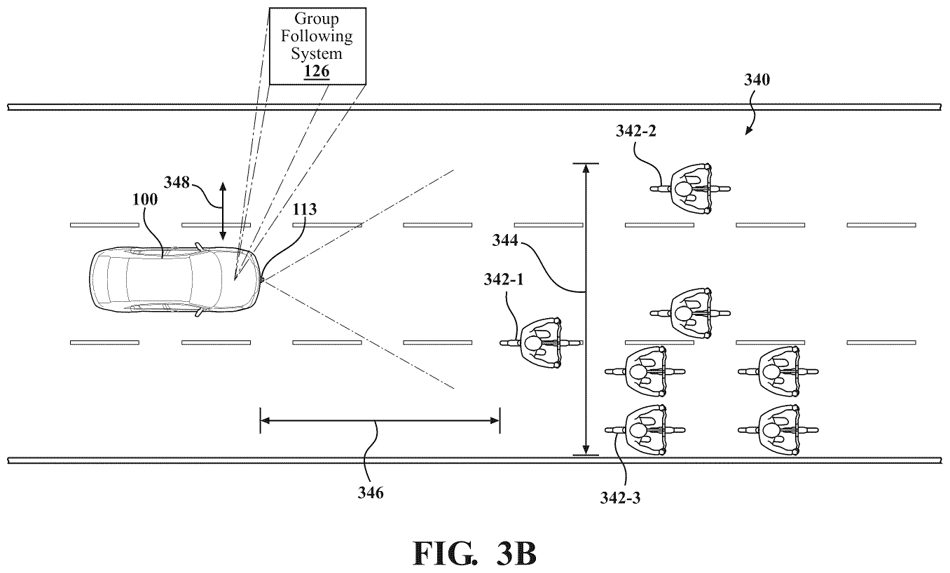

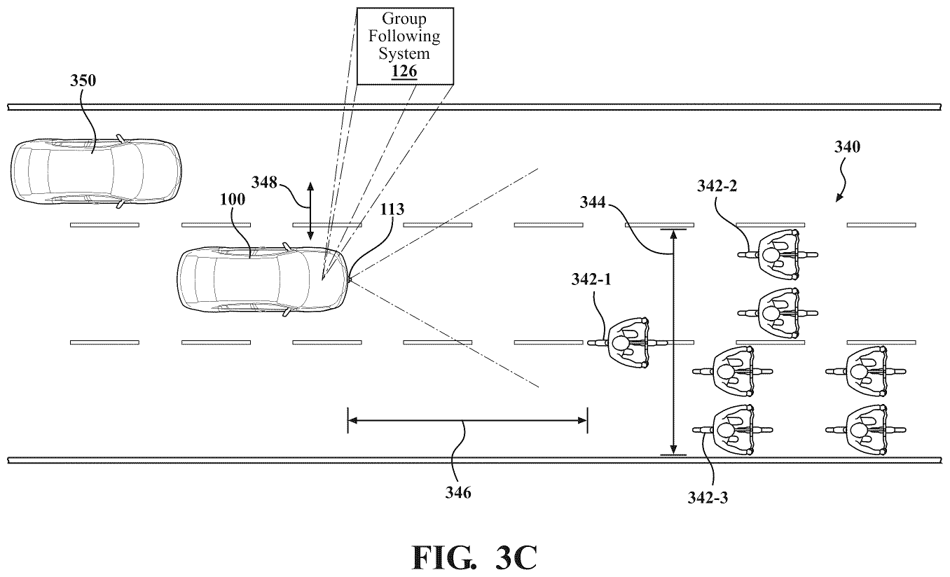

As another example, as described above, a machine vision system may be able to track the position/speed/movement of objects by analyzing the position of an object over various frames of sensor output. The follow module 236 may be able to do so for various detected objects. Accordingly, by comparing the position/speed/movement data of multiple objects, the follow module 236 may define objects with similar position/speed/movement data as being within the group or peloton and those with dissimilar position/speed/movement data as may be designated as non-group entities. For example, a vehicle may travel past the group at a higher speed, or a single cyclist may pass the group in an opposite direction. In either of these examples and others, the follow module 236 may track the objects (e.g., the group of cyclists/bicycles, passing vehicle, and oncoming cyclist) and, based on calculated position/speed/movement data, differentiate between these entities to effectively identify (and track) the group while not tracking non-group entities. Accordingly, in a sensor-based system, the follow module 236 includes instructions that cause the processor 232 to capture camera images or other environment sensor(s) 109 output and analyze such to detect and track different objects within the images or other output and identify within the images and other output, a group of bicycles/cyclists to be followed. FIGS. 3A-3C depict the operation of a sensor-based group following system 126.

In another example, the group following system 126 may be a transceiver-based system where identifying the group to be followed is based on data transmitted from a transceiver of at least one cyclist device or bicycle device. For example, as described above, it may be the case that a cyclist does not have access to a vehicle that could provide the autonomous bike following service as described above. In this example, the cyclist, through a personal electronic device such as a phone, laptop, desktop computer, etc., may submit a request for a bike following autonomous vehicle.

In an example, the request may include a variety of information, such as characteristics of a desired following vehicle, a time, location, and duration for the bike following service, and information identifying the cyclist making the request. For example, it may be that the requesting cyclist is a part of a large group. Accordingly, it may be desirable for a larger vehicle, or even multiple vehicles, to follow behind the group to provide the desired protection. As another example, it may be that the group intends to ride for a duration exceeding that of an electric vehicle battery. In this case, the cyclist may request an internal combustion vehicle with a longer following capability. While particular reference is made to particular vehicle characteristics, the request by the requesting cyclist may include other vehicle characteristics. In this example, the vehicle may dispatch to 1) a predetermined location where the group ride is to begin, 2) the location of the requesting cyclist (as identified in location information shared when the appointed time for the bike following service arrives), or 3) some other location.

At the appointed time, the group following system 126 may establish a communication path via the communication system 127, with device 129 (e.g., the bicycle or cyclist device), to initiate location information transmission. For example, via a handshake operation, the group following system 126 or the cyclist/bicycle device, via the communication system 127, may submit a request to the other entity to establish a wireless communication path between the two. Following authentication, the group following system 126 and the bicycle/cyclist device 129 may transmit information to one another via any number of wireless networks as described below in connection with FIG. 1.

In an example, when bike following is to begin, the group following system 126 may establish wireless communications with other bicycle/cyclist devices 129 in the group. For example, following the establishment of wireless communication with the requesting cyclist, the group following system 126 may broadcast a near-field request to join the group. In this example, cyclist/bicycle devices 129 within the group may respond with data packets and device identifiers such that the group following system 126 may communicate with these cyclists via the communication system 127 and the respective communication systems of the cyclist/bicycle devices 129. In another example, each cyclist who desires to join the group may submit a request to join the group to the group following system 126. In this example, the group following system 126 may receive the requests, authenticate such, and when authenticated, establish a wireless connection with the respective cyclist/bicycle devices 129 based on metadata (e.g., identifiers) included in the requests or responses to the request. In these examples, the follow module 236 may identify the group based on received packets from different cyclists/bicycle devices 129 that form the group.

In another example, identification of the group may be based on manually input information from the requesting cyclist. For example, the requesting cyclist in a pre-ride for-hire request or at the beginning of the group ride may indicate the number of bicycles/cyclists in the group. This may facilitate the follow module 236 tracking the group as a predetermined quantity of cyclists in the group is provided, and the follow module 236 may not be triggered to differentiate non-group entities from group cyclists. In any case (i.e., environment sensor output-based systems and transceiver-based systems), the follow module 236 identifies those cyclists that form a group that is to be followed autonomously for the protection of the group.

The follow module 236 also establishes a following distance, which following distance represents a longitudinal distance along a travel path of the group, that the vehicle 100 is to follow the group. The determination of this following distance may also vary and be based on the type of system. For example, in a sensor-based system, the follow module 236 may determine the last bicycle/cyclist of the group. As described above, this may be based on image processing. When the position of the last cyclist is determined via image processing, the follow module 236 may determine the relative position of the vehicle 100 based on the following distance.

In a transceiver-based system, the follow module 236 may determine the last bicycle/cyclist of the group based on transmitted data. For example, via respective communication systems 127, each cyclist/bicycle device 129, including the last cyclist/bicycle device, may periodically (e.g., every second, every 10^{th} of a second, etc.) transmit its location. The follow module 236 may receive this location information, determine a relative longitudinal distance behind the location information of the last cyclist/bicycle device 129, and transmit such to the control module 238 that the vehicle 100 may be controlled to follow the group at the following distance.

In either of these examples, an administrator or the requesting cyclist may set the following distance. For example, to ensure safety, an administrator may set a default following distance representing a distance where the vehicle 100 may provide rearward protection of the group while being unlikely to collide with any cyclists should the cyclists unexpectedly stop. In another example, the requesting cyclist may set the following distance as part of an initial request or before or during the bike-following activities. In this example, the following distance may reflect the distance between the vehicle 100 and the last bicycle/cyclist device 129. Accordingly, in either a sensor-based system or a transmitted data-based system, once the last cyclist is identified, the follow module 236 adds a longitudinal distance representing the following distance to the longitudinal position of the detected last cyclist/bicycle device 129 and transmits such to the control module 238 for operating the vehicle 100.

In one particular example, the following distance received by the requesting cyclist is the distance between the vehicle 100 and the requesting cyclist, who is not the last bicycle/cyclist device 129. In this example, the requesting cyclist should account for the length of the group when inputting the following distance. For example, it may be that the requesting cyclist is a lead cyclist, and other bicycles/cyclists in the group do not have data transmission capabilities or are not paired with the group following system 126. In a specific numeric example, the requesting cyclist may transmit the following distance of 25 meters, which accounts for the length of the group (e.g., 10 meters) and a determined safe distance between the last cyclist and the vehicle 100 (e.g., 15 meters). Accordingly, in this system, the follow module 236 adds a longitudinal distance representing the following distance (e.g., 25 meters) to the longitudinal position of the requesting/lead cyclist/bicycle device 129 and transmits such to the control module 238 for operating the vehicle 100. As such, the follow module 236 identifies the group and determines an appropriate distance behind the group where the vehicle 100 should be positioned to provide protection and safety to the group from other roadway users and the vehicle 100 itself.

The follow module 236 also calculates a width of the group. That is, rather than simply tracking a longitudinal distance of a transmitting cyclist, the follow module 236 generates a control signal by which the vehicle 100 travels at a lateral position (perpendicular to the longitudinal position of the travel direction of the group) customized to the group. For example, some groups may be broad, while others may be narrower. A follow module 236 that follows the group at a predetermined lateral position behind one transmitting or last bicycle/cyclist device 129 may expose some cyclists/bicycles at the peripheral edges of the group to danger from other roadway traffic. Accordingly, the group following system 126 that follows a group of cyclists/bicycles at a lateral position specific to the group may provide enhanced protection.

Calculation of the width of the group may be performed in various ways. In general, the follow module 236 includes instructions that cause the processor 232 to identify the location of a leftmost cyclist of the group and the location of a rightmost cyclist of the group. The instructions then cause the processor 232 to calculate a distance between the location of the leftmost cyclist and the position of the rightmost cyclist.

In an environment sensor output-based group following system 126, the follow module 236 may, via image processing, identify the leftmost and rightmost cyclists that make up the group as differentiated from environmental dynamic (e.g., other cyclists, pedestrians, animals, and vehicles) and static (e.g., roadway infrastructure elements, trees, etc.) objects. The follow module 236 may then calculate the real-world position of each. That is, via image analysis, the follow module 236 may be able to calculate real-world coordinates or data coordinates for various objects detected by the environment sensor(s) 109. With this information, the follow module 236 may be able to identify the real-world distance between the real-world or image coordinates of the leftmost and rightmost cyclists of the group, for example, via a coordinate-based distance calculation.

In the transceiver-based group following system 126, the follow module 236 may identify the leftmost and rightmost cyclists based on transmitted information. For example, the location information transmitted by the various cyclist/bicycle devices 129 may indicate the lateral coordinates of respective bicycle/cyclist devices 129. From this information, the follow module 236 may identify a group member with a lateral component of their respective location coordinate that indicates a leftmost position and a group member with a lateral component of their respective coordinate information that indicates a rightmost position. The follow module 236 may then identify the distance between the lateral components of the leftmost and rightmost entity, for example, via a coordinate-based distance calculation.

The follow module 236 generally includes instructions that function to control the processor 232 to receive data inputs from one or more sensors of the vehicle 100. The inputs are, in one embodiment, observations of one or more objects in an environment proximate to the vehicle 100 and/or other aspects about the surroundings. As provided for herein, the follow module 236, in one embodiment, acquires sensor data 230 that includes at least camera images. In further arrangements, the follow module 236 acquires the sensor data 230 from further sensors such as a radar sensor 110, a LiDAR sensor 111, and other sensors as may be suitable for identifying dynamic and static objects and the locations of the locations of the dynamic and static objects.

Accordingly, the follow module 236, in one embodiment, controls the respective sensors to provide the data inputs in the form of the sensor data 230. Additionally, while the follow module 236 is discussed as controlling the various sensors to provide the sensor data 230, in one or more embodiments, the follow module 236 can employ other techniques to acquire the sensor data 230 that are either active or passive. For example, the follow module 236 may passively sniff the sensor data 230 from a stream of electronic information provided by the various sensors to further components within the vehicle 100. Moreover, the follow module 236 can undertake various approaches to fuse data from multiple sensors when providing the sensor data 230 and/or from sensor data acquired over a wireless communication link from one or more of the bicycle/cyclist devices 129. Thus, the sensor data 230, in one embodiment, represents a combination of perceptions acquired from multiple sensors.

Moreover, the follow module 236, in one embodiment, controls the sensors to acquire the sensor data 230 about an area that encompasses 360 degrees about the vehicle 100 in order to provide a comprehensive assessment of the surrounding environment. Of course, in alternative embodiments, the follow module 236 may acquire the sensor data about a forward direction alone when, for example, the vehicle 100 is not equipped with further sensors to include additional regions about the vehicle and/or the additional regions are not scanned due to other reasons (e.g., unnecessary due to known current conditions).

The group following system 126 also includes a control module 238 that includes instructions that cause the processor 232 to control the vehicle 100 based on the following distance and the width of the group. In general, the control module 238 interacts with the automated driving module(s) 125 and/or the vehicle systems 116 to guide the vehicle 100 at a longitudinal position that tracks the longitudinal position of the group, albeit behind the group, based on the following distance. The control module 238 also positions the vehicle laterally (in a direction orthogonal to the direction of travel of the group) based on a calculated width of the group.

Specifically, the control module 238 transmits control signals based on information received from the follow module 236 that position the vehicle 100 at a predetermined longitudinal distance behind the group (i.e., the following distance) and at a predetermined lateral position relative to the group. Note that in either of these examples, as the group moves along a path, and as the width of the group changes over time, the control module 238 may, in real-time, adjust the longitudinal and lateral position of the vehicle 100. As a particular example, the group width may change (i.e., become wider or narrower) for any number of reasons (e.g., weather conditions, tightening the formation to further wind resistance, the width of the roadway, path obstacles, etc.). Accordingly, the lateral position of the vehicle 100 may change based on changes in the position of the group.

In an example, the control module 238 includes instructions that cause the processor 232 to center the vehicle 100 behind the group based on the width of the group. Centering the vehicle behind the group may provide a desired protective effect as it may result in the greatest percentage of the width of the group being protected along a rear face. Note that centering the vehicle 100 behind the group based on the width of the group may be different than simply centering the vehicle 100 behind a particular cyclist (e.g., leading/requesting cyclist or the last cyclist). For example, the last cyclist may be closer to one peripheral edge (e.g., the right side) of the group. Were the vehicle 100 to align directly behind the last cyclist on the right, those cyclists on the left may not be afforded the physical protection/barrier the following vehicle 100 provided. In this example, the control module 238 may transmit the control signals to the other components of vehicle 100, such as via a bus, as depicted in FIG. 1.

In an example, the control module 238 may control other components of the vehicle 100. Specifically, the control module 238 may include instructions that cause the processor 232 to alter an operation of the vehicle 100 based on a detected environmental condition. For example, when riding in the dark, the vehicle 100 may intensify the headlight emission or turn on the “high beams” to provide greater illumination of the roadway to the cyclists. In this example, the control module 238 may also decrease the following distance to increase the visibility of the cyclists to motorists and other road users by an amount to prevent a collision between a fallen cyclist and the vehicle 100.

In another example, when a roadway surface is rough and may be more likely to cause a cyclist of the group to fall, the vehicle 100 may increase the following distance to ensure that the vehicle is able to stop responsive to any fall of the cyclist. In either case, the control module 238 generates control signals based on the output of the follow module 236, which control signals are used by the automated driving module(s) 125 and/or vehicle systems 116 to position and move the vehicle 100 behind the group based on the width of the group. By basing the control on the width of the group, the present group following system 126 provides enhanced protection specific to the group and in the face of changes to the configuration (i.e., borders) of the group.

FIGS. 3A-3C depicts one embodiment of a sensor-based group following system 126 for following a group 340 of cyclists 342. For simplicity in the following figures, a few instances of cyclists 342-1, 342-2, and 342-3 are depicted with reference numbers. In the present specification, the presence of an identifier “-*” indicates a particular instance of an element, while the absence of this identifier indicates a general instance of the element.

As described above, the vehicle 100 may follow the group 340 of cyclists at a predetermined following distance 346, which predetermined following distance 346 may be determined by a requesting cyclist/bicycle or set by an administrator. Also as described above, the group following system 126 may control the lateral position of the vehicle 100 (i.e., along the line 348) based on a calculated width 344 of the group 340. FIGS. 3A-3C depict an example of an environment sensor-based group following system 126 where the group following system 126 determines the width 344 of the group 340 based on the output of an environment sensor such as a camera 113. While FIGS. 3A-3C depict a camera 113 as the group detecting sensor; a variety of other environment sensor(s) 109 may be used, either instead of or in combination with the camera 113, to detect the group 340 of cyclists.

As described above, the environment sensor (e.g., the camera 113) has a field of view in front of the vehicle 100 that detects dynamic and static objects. Via this environment sensor(s) 109, the group following system 126 identifies the presence and location of cyclists 342 of the group 340. Also as described above, the follow module 236 of the group following system 126 may differentiate members of the group 340 from non-group entities such as other motorists, pedestrians, single riders that do not form part of the peloton, etc.

In this example, the movement of vehicle 100 along the longitudinal direction, or the direction/path of travel of the group 340 may be based on the detected movements of the group 340. That is, the group 340 may travel in non-linear paths across curved roads and around bends in the road and may change lanes, etc. In this example, the environment sensor 109 suite may detect this movement and guide the longitudinal and lateral positioning of the vehicle 100 based on such.

As described above, the lateral position of the vehicle 100 is based on a width 344 of the group 340. Accordingly, the group following system 126, based on collected sensor data 230 from the environment sensor(s) 109 (e.g., the camera 113), may determine the location of a leftmost cyclist 342-2 and the location of a rightmost cyclist 342-3. That is, the follow module 236 includes instructions that cause the processor 232 to 1) capture environment sensor(s) 109 output of the group 340, 2) analyze the environment sensor(s) 109 output to identify the location of the leftmost cyclist 342-2 of the group 340, and 3) analyze the environment sensor(s) 109 output to identify the location of the rightmost cyclist 342-3 of the group 340. Based on this information, the group following system 126 may determine the width 344 of the group 340, for example, via coordinate-based distance calculations, and position the vehicle 100 accordingly. For example, the control module 238 may position the vehicle 100 at a center point across the width of the group 340.

Note that as depicted in FIGS. 3A-3C , in some examples, the action of the group following system 126 may override other autonomous driving module(s) 125 of the vehicle 100. For example, it may be that the autonomous driving module(s) 125 keeps the vehicle 100 in a single traffic lane. However, to adequately protect the cyclists 342, the group following system 126 may generate a control signal that overrides this lane-keeping assist functionality. Accordingly, in some examples, the group following system 126 includes instructions that cause the processor 232 to override or disable certain autonomous driving module(s) 125 to provide the intended protection to the cyclists.

As depicted in FIGS. 3A-3C and as described above, the vehicle 100 may follow the group 340 by a predetermined following distance 346, which in the example depicted in FIGS. 3A-3C, is a distance maintained between the vehicle 100 and the last cyclist 342-1 of the group 340 as detected by the environment sensors 109 of the vehicle 100.

As described above, the characteristics of group 340 may change over time. For example, as depicted in FIG. 3B, the leftmost cyclist 342-2 may change position. The group following system 126 of the present specification may account for this change. Specifically, the follow module 236 may identify the change in position of the leftmost cyclist 342-2 through the sensor data 230 and may re-calculate and/or update the width 344 value of the group 340. Based on this change, the control module 238 may operate/move the vehicle 100 to better protect the group 340. Specifically, as depicted in FIG. 3B, the vehicle 100 may adjust its lateral position such that the vehicle 100 is more centrally located between the different members of the group 340. Note that the vehicle 100 may still follow the group 340 at the predetermined following distance 346, but with a different lateral position to block the group 340 from rearward traffic more fully.

In the example depicted in FIG. 3C, the vehicle 100 may alter its group width-based lateral position based on a detected passing vehicle 350. Specifically, in addition to forward-facing environment sensor(s) 109, the vehicle 100 may be equipped with backward-facing environment sensor(s) 109. In this example, responsive to a detected passing vehicle 350, the control module 238 may include instructions that cause the processor 232 to control/move the vehicle 100 between the detected passing vehicle 350 and the group 340. In so doing, the vehicle 100 is a physical barrier between the passing vehicle 350, which may not be aware of, or drive responsibly around the group 340 of cyclists 342.

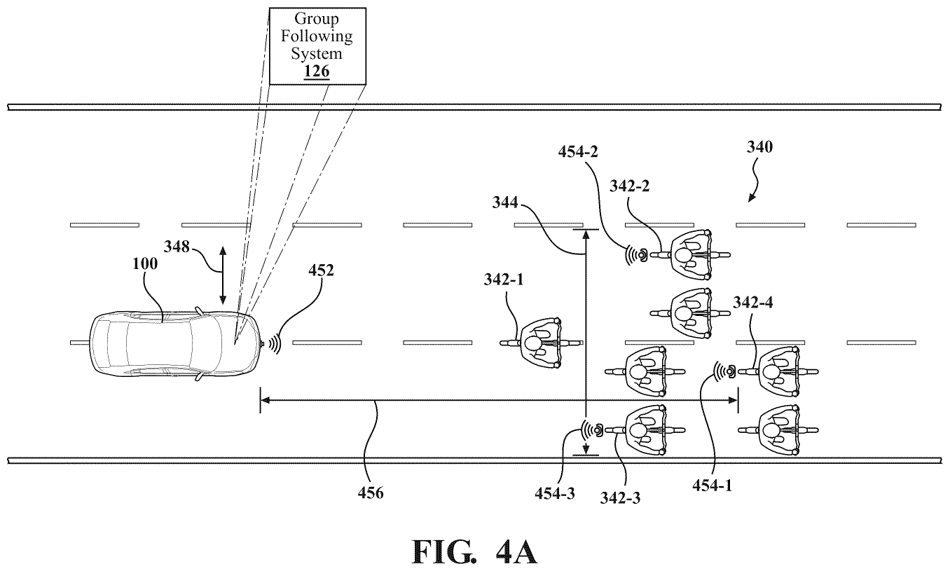

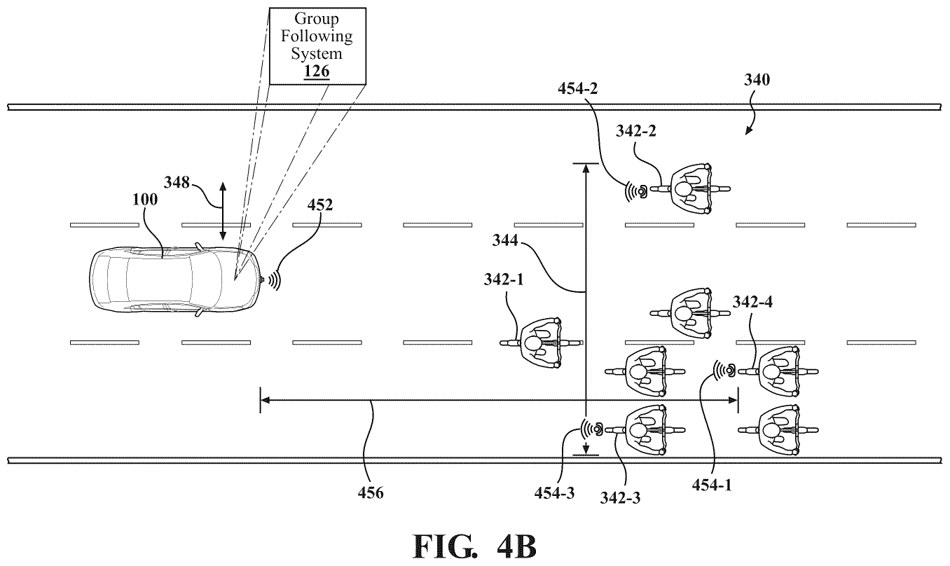

FIGS. 4A and 4B depict one embodiment of a transceiver-based group following system 126 for following a group 340 of cyclists 342. Again, for simplicity in the following figures, a few instances of cyclists 342-1, 342-2, 342-3, and 342-4 are depicted with reference numbers.

As described above, the vehicle 100 may follow the group 340 of cyclists 342 at a predetermined following distance 456, which predetermined following distance 456 may be determined by a requesting cyclist/bicycle or set by an administrator. In the example depicted in FIGS. 4A and 4B, the predetermined following distance 456 is a distance 1) behind a requesting cyclist 342-4, who is not the last cyclist 342-1 and 2) that accounts for a length of the group 340 as described below.

Also as described above, the group following system 126 may control the lateral position of the vehicle 100 (i.e., along the line 348) based on a calculated width 344 of the group 340. FIGS. 4A and 4B depict an example of a transceiver-based system where the group following system 126 determines the width 344 of the group 340 based on received transmissions from one or more of the cyclists of the group 340. In this example, the vehicle 100 may be equipped with a wireless transceiver 452, and at least one of the cyclists 342 may also be equipped with a wireless transceiver 454-1, 454-2, and 454-3. In an example, the wireless transceivers 454-1, 454-2, and 454-3 associated with the cyclists 342 may be found on the bicycles themselves as hardware or may be included in the personal devices of the cyclists 342 riding the bicycles.

In either example, the follow module 236 may include instructions that cause the processor 232 to establish a communication link between a transceiver 454-1, 454-2, and 454-3 of a cyclist 342-2, 342-3, and 342-4 of the group 340 and a transceiver 452 of the vehicle 100. Via this communication link, the requesting cyclist 342-4 may periodically transmit its location and other information defining the group 340. In other words, via this communication link, the vehicle 100 and one or more of the cyclists 342 are wirelessly connected for transferring signals between one another. As described above, this wireless communication link may be via different protocols such as 3G, 4G, 5C, LTE, evolution-data optimized (EVDO), code vision multiple access (CDMA), GSM, general packet radio service (GPRS), WiFi, DSRC, or other protocols. In an example, the wireless communication may be of other types, such as infrared or Bluetooth^{®}.

Whatever protocol is used, the vehicle 100, the requesting cyclist 342-4, and any number of other cyclists 342-2 and 342-3 that include a wireless transceiver 454 may, via a handshake operation, establish a wireless communication link. Such a handshake may include a request by either the vehicle 100 to the cyclists 342 or from the bicycle/cyclist devices 129 to the vehicle 100. Responsive to the request, a confirmation message is transmitted, which may establish the wireless link. In either example, via this handshake/pairing operation, the vehicle 100 is in wireless communication with at least the requesting cyclist 342-4 of the group 340.

Via the wireless transceiver 452 and 454 pairing, the group following system 126 identifies the presence and location of cyclists of the group 340. That is, as described above via a broadcast message or a prompt, each of the cyclists in the group 340 may provide the group following system 126 with identifying data and a location of the respective cyclist 342. Moreover, as another example, via this link, the requesting cyclist 342-4 may indicate the number of cyclists 342 in the group 340. Accordingly, rather than manually detecting such in the captured environment sensor(S) 109 output, the group following system 126 may be guided or trained on the number of cyclists 342 to identify.

Movement of the vehicle 100 along the longitudinal direction, or the direction/path of the group 340 may be based on the received position changes of the various wireless transceivers 454-1, 454-2, and 454-3. That is, the group 340 may travel in non-linear paths across curved roads and around bends in the road and/or may change lanes, etc. In this example, the periodic transmission of location coordinates from various transceivers 454-1, 454-2, and 454-3 may provide the follow module 236 with real-time sensor data 230, which is relied on to guide the longitudinal and lateral positioning of the vehicle 100.

As described above, the lateral position of the vehicle 100 is based on a width 344 of the group 340. Accordingly, the group following system 126, based on coordinate information received from various wireless transceivers 454-1, 454-2, and 454-3, may determine the location of a leftmost cyclist 342-2 and the location of a rightmost cyclist 342-3. That is, the follow module 236 includes instructions that cause the processor 232 to 1) receive, from transceivers 454 of cyclists 342 within the group 340, transmitted location coordinates for a respective device 129 of a cyclist 342, 2) identify location coordinates of the leftmost cyclist 342-2 of the group 340, 3) identify location coordinates of the rightmost cyclist 342-3 of the group 340; and 4) calculate a distance between the location coordinate of the leftmost cyclist 342-2 and the location coordinate of the rightmost cyclist 342-3. As described above, this may include analyzing the location coordinates using coordinate-based distance calculations. Based on this information, the group following system 126 may determine the width 344 of the group 340 and position the vehicle 100 accordingly. For example, the control module 238 may position the vehicle 100 at a center point across the width of the group 340.

As depicted in FIGS. 4A-4B and as described above, the vehicle 100 may follow the group 340 by a predetermined following distance 456, which in the example depicted in FIGS. 4A and 4B, is a distance maintained between the vehicle 100 and a requesting cyclist 342-4 of the group 340, which following distance may be indicated in a data packet from the requesting cyclist 342-4. Specifically, the follow module 236 includes instructions that cause the processor 232 to receive a predetermined following distance from a device 129 of a requesting cyclist 342-4 and control the vehicle 100 to follow the requesting cyclist 342-4 based on the predetermined following distance and the location of the requesting cyclist 342-4. As described, in the case where the requesting cyclist 342-4 is not the last cyclist 342-1, this requesting cyclist-to-autonomous vehicle distance should account for the length of the group 340 such that the vehicle 100 follows the last cyclist 342-1 by a safe margin.

Via this communication link, the vehicle 100 may send information to the requesting cyclist 342-4, and other cyclists 342, as well. For example, it may be that the environment sensor(s) 109 of the vehicle 100 detects another cyclist in the vicinity of the group 340, but who is not yet part of the group 340. Via this communication link, the follow module 236 may generate a prompt for the requesting cyclist 342-4 to indicate whether the additional cyclist should be added to the group 340 and accounted for when laterally navigating the vehicle 100.

As described above, the characteristics of group 340 may change over time. For example, as depicted in FIG. 4B, the leftmost cyclist 342-2 may change position. The group following system 126 of the present specification may account for this change. Specifically, the follow module 236 may identify the change in position of the leftmost cyclist 342-2 through the periodic transmission of location coordinates from the leftmost wireless transceiver 454-2 and re-calculate and/or update the width 344 value of the group 340. Based on this change, the vehicle may move to protect the group 340 better. Specifically, as depicted in FIG. 4B, the vehicle 100 may adjust its lateral position (i.e., along the line 348) such that the vehicle 100 is more centrally located between the different members of the group 340. Note that the vehicle 100 still follows the group 340 at the predetermined following distance 456 but with a different lateral position to block the group 340 from rearward traffic more fully.

Note that while FIGS. 3A-4B depict either an environment sensor-based system or a transceiver-based system, the sensor data 230 relied on may be of either type or a combination thereof. For example, a requesting cyclist 342-4 may transmit 1) location coordinates to the group following system 126, from which a general longitudinal path of the vehicle 100 may be determined, and 2) a desired following distance. Still in this example, the environment sensor(s) 109 of the vehicle 100 may be used to 1) determine the width 344 of the group 340 by identifying, in environment sensor(s) 109 output the leftmost cyclist 342-2 and the rightmost cyclist 342-3 and 2) detect the last cyclist 342-1 which serves as a measurement point for the following distance. That is, the group following system 126 may be a sensor-based system, a transceiver-based system, or a combination of both. In any case, the present group following system 126 allows for the width-based following of a vehicle 100 behind the group 340 of cyclists 342 to ensure the safety of grouped bike riding.

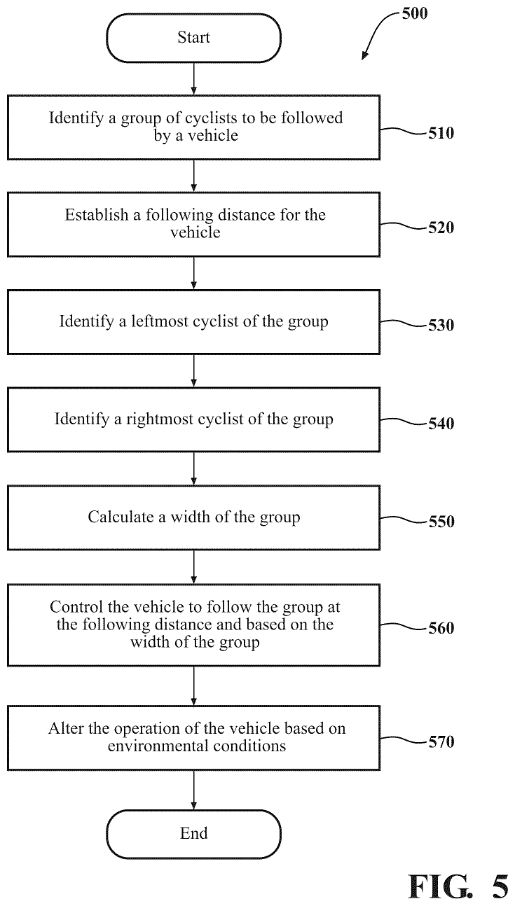

Additional aspects of customizing bike following behaviors of a vehicle 100 with autonomous driving capabilities will be discussed in relation to FIG. 5. FIG. 5 illustrates a flowchart of a method 500 that is associated with determining a group following position of a vehicle 100. Method 500 will be discussed from the perspective of the group following system 126 of FIGS. 1 and 2. While method 500 is discussed in combination with the group following system 126, it should be appreciated that the method 500 is not limited to being implemented within the group following system 126 but is instead one example of a system that may implement the method 500.

At 510, the group following system 126 identifies a group 340 of cyclists 342 to be followed. The identification operation may include multiple stages. First, as described above, it may be the case that a cyclist 342 does not have access to an autonomous vehicle with bike-following capability. In this example, the cyclist 342 may “rent,” “hire,” or temporarily acquire a vehicle 100 with bike-following capability. For example, through a webpage or an application, a cyclist 342 may fill out a request for an autonomous bike following service. Responsive to this transmitted request, a vehicle 100 may be identified and assigned to the cyclist 342 for a period of time. That is, a remote server may transmit a dispatch command to the vehicle 100 that meets the criteria specified in the transmitted request from the cyclist 342, wherein the command indicates a location, duration, date, etc., associated with the bike following request.

In an example, the transmitted request from the cyclist 342 may have a variety of fields or group following parameters. Examples of fields or following parameters include a location where the group following is to begin, a date and time associated with the following activity, the duration of the following activity, the length of an anticipated ride, and others. As a specific example, the transmitted request may indicate a type of vehicle 100 to be dispatched. For example, the group 340 may be small and have a short ride duration (e.g., 1-2 hours). In this example, a smaller vehicle (e.g., a sedan) with an electric power source may be implemented. However, such a vehicle may not be suited for a larger group 340 that is to ride longer. In this example, a larger vehicle, such as a truck with a longer range (e.g., an internal combustion engine), may be selected. In either case, a remote server may acquire this information and select an appropriate vehicle to fulfill the request. That is, the remote server may include a database that maps requested parameters to vehicle parameters such that a vehicle that matches the requested parameters (e.g., is available at the requested dates and times, can follow for the requested duration, is near the identified starting position, etc.) is identified. While particular references are made to particular criteria for selecting a following vehicle from a pool of vehicles, any number of these criteria or others may be used to select a particular following vehicle. As another example, a usage rate may be relied on where less used or less recently used vehicles may be selected over more often or more recently used vehicles.

When a target vehicle is selected, the remote server sends a dispatch command to the vehicle 100. The group following system 126 includes instructions that cause the processor 232 to receive the transmitted dispatch command from the remote server, which dispatch command identifies the cyclist 342, for example, via a unique identifier, that the group following system 126 is to connect with at the starting point, and the starting location for the ride, whether that location is a predetermined starting location or coordinates of the cyclist 342 at the time the ride is to begin.

In this later example, rather than including the predetermined starting point for a group ride, the request may include an instruction for the group following system 126 to pair with the requesting cyclist 342-4 at the appointed time and obtain the location of the requesting cyclist 342-4. In this example, rather than dispatching to the predetermined location, the vehicle 100 may dispatch to the location obtained following pairing.

Accordingly, in this example, the cyclist 342 searches for, identifies, and schedules a vehicle 100 with autonomous group following capability. On the scheduled date and time, the vehicle 100 arrives at the predetermined location and pairs with the requesting cyclist 342-2 and or other cyclists 342.

During the second stage, i.e., when group following begins, whether previously scheduled via a rental service or otherwise, the group following system 126 physically identifies those cyclists 342 to be followed. In the case that the vehicle 100 has been previously reserved by a cyclist 342, upon arrival at the agreed-upon starting location, the vehicle 100 and the requesting cyclist 342-4 or other cyclists 342 may pair with one another via the transmission of various handshake data packets as described above. For example, the request may include an identifier of the requesting cyclist 342-4. Accordingly, upon arrival, the vehicle 100 and/or the requesting cyclist 342-4 may broadcast a connection request, and the other device (e.g., the requesting cyclist 342-2 or the vehicle 100) may send a confirmation data packet acknowledging the establishment of a wireless connection and a following relationship.

In the case that the vehicle 100 is not previously reserved, a similar operation may occur where, before starting a group ride, the vehicle 100 and any number of cyclists 342, including the requesting cyclist 342-4, may establish a wireless connection. As described above, this wireless connection may be the basis for determining the following distance, calculating a width 344 of the group 340, and determining a lateral position for the vehicle 100 based on the calculated width.

In the example where the group following system 126 is sensor-based, the identification may be based on the environment sensor(s) 109 output analysis as described above. That is to say, the group following system 126 may detect and track objects in frames of environment sensor(s) 109 output whether that output is camera images or the output of other environments sensor(s) 109 such as LiDAR sensor(s) 111, radar sensor(s) 110, sonar sensor(s) 112, or others.

That is to say, the follow module 236 controls the sensor system 107 to acquire the sensor data 230. In one embodiment, the follow module 236 controls the radar sensor 110 and the camera 113 of the vehicle 100 to observe the surrounding environment. Alternatively, or additionally, the follow module 236 controls the camera 113 and the LiDAR sensor 111 or another set of sensors to acquire the sensor data 230. As part of controlling the sensors to acquire the sensor data 230, it is generally understood that the sensors acquire the sensor data 230 of a region around the vehicle 100, with data acquired from different types of sensors generally overlapping to provide for a comprehensive sampling of the surrounding environment at each time step. In general, the sensor data 230 need not be of the exact same bounded region in the surrounding environment but should include a sufficient area of overlap such that distinct aspects of the area can be correlated. Thus, the follow module 236, in one embodiment, controls the sensors to acquire the sensor data 230 of the surrounding environment.

Moreover, in further embodiments, the follow module 236 controls the sensors to acquire the sensor data 230 at successive iterations or time steps. Thus, the group following system 126, in one embodiment, iteratively executes the functions discussed at blocks 510-570 to acquire the sensor data 230 and provide information therefrom. Furthermore, the follow module 236, in one embodiment, executes one or more of the noted functions in parallel for separate observations in order to maintain updated perceptions. Additionally, as previously noted, the follow module 236, when acquiring data from multiple sensors, fuses the data together to form the sensor data 230 and to provide for improved determinations of detection, location, and so on.

At 520, the follow module 236 establishes a following distance for the vehicle 100. As described above, the following distance may be a distance 346 that the vehicle 100 follows behind the last cyclist 342-1 as identified by sensor data 230 capturing the group 340 or a transmitted location from a transceiver 454 of the last cyclist 342-1. In another example, the following distance may be a distance 456 that the vehicle 100 follows behind a requesting cyclist 342-4 that is not the last cyclist 342-1, which distance between the requesting cyclist 342-4 and the vehicle 100 accounts for a length of the group 340. In some examples, a manufacturer or safety administrator may set the following distance. In other examples, the following distance is set by the requesting cyclist 342-4.

In either case, at 530, the group following system 126 identifies a leftmost cyclist 342-2 of the group 340, and at 540, the group following system 126 identifies a rightmost cyclist 342-3 of the group 340. At 550, the group following system 126 calculates a width 344 of the group 340 based on the location of the leftmost cyclist 342-2 and the location of the rightmost cyclist 342-3. As described above, this may take various forms based on the type of sensor data 230.

For example, in a sensor-based group following system 126, environment sensor(s) 109 capture images of the group 340, identify individual entities within the group 340, and calculate the real-world position of such. From this information, the follow module 236 of a sensor-based group following system 126 may, using a coordinate-based methodology, calculate the distance between the leftmost and rightmost cyclists 342-2 and 342-3, which distance reflects the width 344 of the group 340.

In a transceiver-based group following system 126, a wireless transceiver 452 of the vehicle 100 receives transmitted location information from the cyclists 342 in the group 340, which location information is collected by environment sensors on the cyclist device or a bicycle device. From this transmitted information, the follow module 236 of a transceiver-based group following system 126 may, using a coordinate-based methodology, calculate the distance between the leftmost and rightmost cyclists 342-2 and 342-3, which distance reflects the width 344 of the group 340.

In either case, at 560, the control module 238 controls the vehicle 100 to follow the group 340 at the following distance and based on the width 344 of the group 340. For example, the control module 238 may generate control signals used by the automated driving module(s) 125 and/or vehicle systems 116 to position and move the vehicle 100 behind the group 340 along a longitudinal path that follows the group 340. Moreover, the control module 238 may generate control signals used by the automated driving module(s) 125 and/or vehicle systems 116 to position and move the vehicle 100 behind the group 340 at a lateral position based on the width 344 of the group 340. For example, the control module 238 may center the vehicle 100 behind the group 340. As the width 344 of the group 340 may change over time, the lateral position of the vehicle 100 may change. Thus, the present method 500 protects the cyclists 342 in the group 340, notwithstanding the different and changing width 344 of the group 340.

At 570, the group following system 126 may alter the operation of the vehicle 100 based on environmental conditions. For example, when following the group 340 under low-light conditions, the headlights of the vehicle 100 may be intensified or set to the high beam setting to provide additional illumination for the cyclists 342 in the group 340. As another example, in reduced visibility conditions, the vehicle 100 may shorten the following distance to provide less opportunity for adjacent vehicles to interact with the cyclists 342. As another example, the vehicle operation and/or following distance may be altered based on the road conditions. For example, when following cyclists 342 on a dirt road filled with ruts, potholes, etc., the vehicle 100 may follow at a greater distance due to an increased likelihood of a cyclist falling.

In any event, when the group ride has terminated (e.g., the duration of the group ride previously provided has expired, or a requesting cyclist 342-4 has manually indicated the termination of the ride), the vehicle 100 may return to a predetermined location and may be returned to a pool of available vehicles.

As such, the present group following system 126 allows a vehicle 100 with autonomous driving capabilities to follow a group 340 of cyclists 342 in a fashion unique to the group 340 (i.e., based on the width 344 of the group 340). This service may be available to cyclists 342 who do not have access to such a vehicle, for example, via a rental service as described above.

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the Society of Automotive Engineers (SAE) J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 101. In one or more arrangements, the processor(s) 101 can be a primary/centralized processor of the vehicle 100 or may be representative of many distributed processing units. For instance, the processor(s) 101 can be an electronic control unit (ECU). Alternatively, or additionally, the processors include a central processing unit (CPU), a graphics processing unit (GPU), an ASIC, an microcontroller, a system on a chip (SoC), and/or other electronic processing units that support operation of the vehicle 100.

The vehicle 100 can include one or more data stores 102 for storing one or more types of data. The data store 102 can be comprised of volatile and/or non-volatile memory. Examples of memory that may form the data store 102 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 102 is a processor(s) 101 component. In general, the data store 102 is operatively connected to the processor(s) 101 for use thereby. The term “operatively connected,” as used throughout this description, can include direct or indirect connections, including connections without direct physical contact.

In one or more arrangements, the one or more data stores 102 include various data elements to support functions of the vehicle 100, such as semi-autonomous and/or autonomous functions. Thus, the data store 102 may store map data 103 and/or sensor data 106. The map data 103 includes, in at least one approach, maps of one or more geographic areas. In some instances, the map data 103 can include information about roads (e.g., lane and/or road maps), traffic control devices, road markings, structures, features, and/or landmarks in the one or more geographic areas. The map data 103 may be characterized, in at least one approach, as a high-definition (HD) map that provides information for autonomous and/or semi-autonomous functions.

In one or more arrangements, the map data 103 can include one or more terrain maps 104. The terrain map(s) 104 can include information about the ground, terrain, roads, surfaces, and/or other features of one or more geographic areas. The terrain map(s) 104 can include elevation data in the one or more geographic areas. In one or more arrangements, the map data 103 includes one or more static obstacle maps 105. The static obstacle map(s) 105 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 106 is data provided from one or more sensors of the sensor system 107. Thus, the sensor data 106 may include observations of a surrounding environment of the vehicle 100 and/or information about the vehicle 100 itself. In some instances, one or more data stores 102 located onboard the vehicle 100 store at least a portion of the map data 103 and/or the sensor data 106. Alternatively, or in addition, at least a portion of the map data 103 and/or the sensor data 106 can be located in one or more data stores 102 that are located remotely from the vehicle 100.

As noted above, the vehicle 100 can include the sensor system 107. The sensor system 107 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 107 and/or the one or more sensors can be operatively connected to the processor(s) 101, the data store(s) 102, and/or another element of the vehicle 100.

Various examples of different types of sensors will be described herein. However, it will be understood that the embodiments are not limited to the particular sensors described. In various configurations, the sensor system 107 includes one or more vehicle sensors 108 and/or one or more environment sensors. The vehicle sensor(s) 108 function to sense information about the vehicle 100 itself. In one or more arrangements, the vehicle sensor(s) 108 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 107 can include one or more environment sensors 109 that sense a surrounding environment (e.g., external) of the vehicle 100 and/or, in at least one arrangement, an environment of a passenger cabin of the vehicle 100. For example, the one or more environment sensors 109 sense objects the surrounding environment of the vehicle 100. Such obstacles may be stationary objects and/or dynamic objects. Various examples of sensors of the sensor system 107 will be described herein. The example sensors may be part of the one or more environment sensors 109 and/or the one or more vehicle sensors 108. However, it will be understood that the embodiments are not limited to the particular sensors described. As an example, in one or more arrangements, the sensor system 107 includes one or more radar sensors 110, one or more LiDAR sensors 111, one or more sonar sensors 112 (e.g., ultrasonic sensors), and/or one or more cameras 113 (e.g., monocular, stereoscopic, RGB, infrared, etc.).

Continuing with the discussion of elements from FIG. 1, the vehicle 100 can include an input system 114. The input system 114 generally encompasses one or more devices that enable the acquisition of information by a machine from an outside source, such as an operator. The input system 114 can receive an input from a vehicle passenger (e.g., a driver/operator and/or a passenger). Additionally, in at least one configuration, the vehicle 100 includes an output system 115. The output system 115 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 116. Various examples of the one or more vehicle systems 116 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 117, a braking system 118, a steering system 119, a throttle system 120, a transmission system 121, a signaling system 122, and a navigation system 123.

The navigation system 123 can include one or more devices, applications, and/or combinations thereof to determine the geographic location of the vehicle 100 and/or to determine a travel route for the vehicle 100. The navigation system 123 can include one or more mapping applications to determine a travel route for the vehicle 100 according to, for example, the map data 103. The navigation system 123 may include or at least provide connection to a global positioning system, a local positioning system or a geolocation system.

In one or more configurations, the vehicle systems 116 function cooperatively with other components of the vehicle 100. For example, the processor(s) 101, the group following system 126, and/or automated driving module(s) 125 can be operatively connected to communicate with the various vehicle systems 116 and/or individual components thereof. For example, the processor(s) 101 and/or the automated driving module(s) 125 can be in communication to send and/or receive information from the various vehicle systems 116 to control the navigation and/or maneuvering of the vehicle 100. The processor(s) 101, the group following system 126, and/or the automated driving module(s) 125 may control some or all of these vehicle systems 116.

For example, when operating in the autonomous mode, the processor(s) 101, the group following system 126, and/or the automated driving module(s) 125 control the heading and speed of the vehicle 100. The processor(s) 101, the group following system 126, and/or the automated driving module(s) 125 cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 100 includes one or more actuators 124 in at least one configuration. The actuators 124 are, for example, elements operable to move and/or control a mechanism, such as one or more of the vehicle systems 116 or components thereof responsive to electronic signals or other inputs from the processor(s) 101 and/or the automated driving module(s) 125. The one or more actuators 124 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory computer-readable instructions that, when executed by the processor 101, implement one or more of the various functions described herein. In various arrangements, one or more of the modules are a component of the processor(s) 101, or one or more of the modules are executed on and/or distributed among other processing systems to which the processor(s) 101 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 125. The automated driving module(s) 125, in at least one approach, receive data from the sensor system 107 and/or other systems associated with the vehicle 100. In one or more arrangements, the automated driving module(s) 125 use such data to perceive a surrounding environment of the vehicle. The automated driving module(s) 125 determine a position of the vehicle 100 in the surrounding environment and map aspects of the surrounding environment. For example, the automated driving module(s) 125 determines the location of obstacles or other environmental features including traffic signs, trees, shrubs, neighboring vehicles, pedestrians, etc.

The automated driving module(s) 125 either independently or in combination with the group following system 126 can be configured to determine travel path(s), current autonomous driving maneuvers for the vehicle 100, future autonomous driving maneuvers and/or modifications to current autonomous driving maneuvers based on data acquired by the sensor system 107 and/or another source. In general, the automated driving module(s) 125 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
identify a group of cyclists to be followed by a vehicle with autonomous driving capability;
establish a following distance for the vehicle, the following distance is a distance maintained between the vehicle and the group;
calculate a width of the group; and
control the vehicle based on the following distance and the width of the group.

2. The system of claim 1, wherein the machine-readable instruction that causes the processor to identify the group comprises a machine-readable instruction that causes the processor to receive a transmitted request from a device of a requesting cyclist, the transmitted request identifies the requesting cyclist and a starting location of a group ride.

3. The system of claim 1, wherein:
the machine-readable instructions further comprise a machine-readable instruction that causes the processor to establish a communication link between a device of a requesting cyclist of the group and the vehicle; and
the machine-readable instruction that causes the processor to establish the following distance comprises a machine-readable instruction that causes the processor to receive a location of the device.

4. The system of claim 1, wherein the following distance is at least one of:
a distance between the vehicle and a last cyclist of the group; and
a distance between the vehicle and a requesting cyclist of the group.

5. The system of claim 1, wherein the machine-readable instruction that causes the processor to calculate the width of the group comprises machine-readable instructions that cause the processor to:
identify a location of a leftmost cyclist of the group;
identify a location of a rightmost cyclist of the group; and
calculate a distance between the location of the leftmost cyclist and the location of the rightmost cyclist.

6. The system of claim 5, wherein the machine-readable instruction that causes the processor to calculate the width of the group comprises machine-readable instructions that cause the processor to:
receive, from devices of cyclists within the group, transmitted location coordinates for a respective cyclist; and
identify location coordinates of the leftmost cyclist of the group;
identify location coordinates of the rightmost cyclist of the group; and
calculate the distance between the location coordinates of the leftmost cyclist and the location coordinates of the rightmost cyclist.

7. The system of claim 5, wherein the machine-readable instruction that causes the processor to calculate the width of the group comprises machine-readable instructions that cause the processor to:
capture environment sensor output of the group;
analyze the environment sensor output to identify the location of the leftmost cyclist of the group; and
analyze the environment sensor output to identify the location of the rightmost cyclist of the group.

8. The system of claim 1, wherein the machine-readable instruction that causes the processor to control the vehicle to follow the group comprises a machine-readable instruction that causes the processor to center the vehicle being the group based on the width of the group.

9. The system of claim 1, wherein the machine-readable instruction that causes the processor to control the vehicle to follow the group comprises a machine-readable instruction that causes the processor to, responsive to a detected passing vehicle, move the vehicle between the detected passing vehicle and the group.

10. The system of claim 1, wherein the machine-readable instructions further comprise a machine-readable instruction that causes the processor to alter an operation of the vehicle based on a detected environmental condition.
